(19) United States
(12) Patent Application Publication
(10) Pub. No.: US 2026/0021516 A1
(43) Pub. Date: Jan. 22, 2026

(54) CLEANING FUNCTIONALITY IN HANDHELD LASER SYSTEM

(71) Applicant: IPG PHOTONICS CORPORATION, Marlborough, MA (US)

(72) Inventors: Iurii MARKUSHOV, Shrewsbury, MA (US); Yuri GRAPOV, Sutton, MA (US); Nam LY, Dudley, MA (US); Sergei NOVIKOV, Boylston, MA (US)

(73) Assignee: IPG PHOTONICS CORPORATION, Marlborough, MA (US)

(21) Appl. No.: 19/347,203

(22) Filed: Oct. 1, 2025

Related U.S. Application Data
(63) Continuation of application No. 18/569,443, filed on Dec. 12, 2023.
(60) Provisional application No. 63/212,280, filed on Jun. 18, 2021.
(60) Provisional application No. 63/242,175, filed on Sep. 9, 2021.

(51) Int. Cl. B08B 7/00

(52) U.S. Cl. CPC B08B 7/0042

(57) ABSTRACT

Systems for passivating a surface using laser radiation are provided. In one example, a system includes a housing configured as a handheld apparatus that directs laser radiation to the surface to be passivated, an optical fiber that couples the handheld apparatus to a laser source, and a laser source that is configured to emit laser radiation in either a continuous wave (CW) mode having a maximum power of 1500 watts (W) inclusive, or a modulated CW mode having a duty cycle less than 100%, a pulse repetition frequency in a range of 30-55 kilohertz (kHz) inclusive, and a FWHM pulse duration of nanosecond order or longer.

### CROSS-REFERENCE TO RELATED APPLICATIONS

This application is a Continuation of U.S. application Ser. No. 18/569,443, filed on Dec. 12, 2023, titled “CLEANING FUNCTIONALITY IN HANDHELD LASER SYSTEM” which is a 371 of PCT/US22/34158 filed on Jun. 20, 2022, titled “CLEANING FUNCTIONALITY IN HANDHELD LASER SYSTEM” which claims priority to U.S. Provisional Patent Application No. 63/212,280, filed on Jun. 18, 2021, titled “CLEANING FUNCTIONALITY IN HANDHELD LASER SYSTEM” and to U.S. Provisional Patent Application No. 63/242,175, filed on Sep. 9, 2021, titled “CLEANING FUNCTIONALITY IN HANDHELD LASER SYSTEM,” the contents of which are herein incorporated by reference in their entirety.

The present application relates to PCT International Application No. PCT/US2021/047498 titled “HANDHELD LASER SYSTEM” filed on Aug. 25, 2021, and to U.S. Provisional Patent Application No. 63/212,290 titled “MATERIAL PROCESSING FUNCTIONALITY IN HANDHELD LASER SYSTEM” filed on Jun. 18, 2021, the contents of which are herein incorporated by reference in their entirety.

### BACKGROUND

### Technical Field

The technical field relates generally to a handheld laser device that can be used for material processing operations, and more specifically to a handheld laser device configured with cleaning functionality.

### Background Discussion

Material processes performed on surfaces can require a cleaning treatment that removes contaminants, such as oxides, organic or inorganic materials, or weld traces from the surface. Laser irradiation can be used to provide heat input onto the surface that vaporizes a top layer of the surface.

Laser-based material processing equipment with high power capacities (e.g., at least 1 kW) have been conventionally used for industrial cutting and welding, but have typically been too expensive for many smaller machine shops or other smaller-scale end users. However, over time the average power of laser diodes has increased significantly while their average price per watt has decreased exponentially. In addition, technological advances have been made in higher power laser systems. These factors make it more feasible to implement higher power lasers into smaller material processing systems, such as handheld laser devices. Such systems would not only be desirable for smaller industrial shops, but these devices would be especially useful in applications where larger systems are impractical or impossible to use.

Besides cutting and welding, other laser-based material processes include drilling, brazing, soldering, cladding, and other heat treatments such as cleaning. Fiber laser technology in particular offers several advantages over other laser technologies, such as excimer or CO₂ systems. Besides lower maintenance costs, fiber laser technology also offers high wall plug efficiencies, long diode lifetimes, and can be more easily transported. Fiber laser cleaning in particular offers significant advantages over other cleaning methods, such as abrasive blasting, cold jetting, chemical cleaning, and thermal cleaning. However, conventional fiber laser cleaning methods up to this time have not offered a high quality, economical mode of cleaning using a fiber-based handheld laser device.

### SUMMARY

Aspects and embodiments are directed to a method and system for cleaning and/or passivating a surface using laser radiation.

In accordance with an exemplary embodiment, there is provided a system for cleaning a surface using laser radiation. In one example, the system includes a laser source configured to generate laser radiation, the laser source configured to emit laser radiation in a cleaning mode, the cleaning mode characterized as a modulated continuous wave (CW) mode having a duty cycle less than 100%, a pulse-repetition frequency of at least 10 kilohertz (kHz), and a FWHM pulse duration in a range of 1 microsecond (μs) to 10 milliseconds (ms) inclusive, a housing configured as a handheld apparatus that directs the laser radiation to the surface, and an optical fiber coupling the handheld apparatus to the laser source.

In one example, the pulse-repetition frequency is in a range of 10-55 kHz inclusive.

In one example, the cleaning mode has a maximum power of 1500 watts (W) inclusive.

In one example, the duty cycle is in a range of 10-95% inclusive.

In one example, the system further includes a controller configured to control the laser source.

In one example, the system further includes at least one movable mirror positioned within the housing, the at least one movable mirror configured to wobble a laser beam of the laser radiation such that the laser beam has a wobble amplitude greater than 5 mm.

In one example, the system further includes a cleaning nozzle configured to attach to the housing and to deliver laser radiation emitted in the cleaning mode onto a surface to be cleaned.

In one example, the cleaning nozzle is configured with an opening that permits the passage of the laser radiation. In a further example, the laser radiation forms a scan line on the surface. In a further example, the opening is further configured to deliver gas to the surface. In one example, the opening is further configured such that a laser beam of the laser radiation has a wobble amplitude of 15 mm. In another example, the cleaning nozzle has a nozzle tip configured with one of: a one-point configuration, a two-point configuration, or a groove. In one example, the nozzle tip is configured to be press fitted onto a tubular body portion of the cleaning nozzle.

In accordance with another exemplary embodiment, there is provided a method for cleaning a surface with a laser. In one example, the method includes providing a laser source, the laser source configured to emit laser radiation in a cleaning mode, the cleaning mode characterized as a modulated continuous wave (CW) mode having a duty cycle less than 100%, a pulse-repetition frequency of at least 10 kilohertz (kHz), and a FWHM pulse duration in a range of 1 microsecond (μs) to 10 milliseconds (ms) inclusive, generating laser radiation from the laser source in the cleaning mode, and directing the laser radiation emitted from the laser source onto a surface to be cleaned.

In one example, the pulse-repetition frequency is in a range of 10-55 kHz inclusive.

In one example, the cleaning mode has a maximum power of 1500 watts (W) inclusive.

In one example, the duty cycle is in a range of 10-95% inclusive.

In one example, the method further includes wobbling a laser beam of the emitted laser radiation such that the laser beam has a wobble length greater than 5 mm.

In one example, the method further includes providing a handheld device that emits the laser radiation.

In one example, the method further includes comprising providing a cleaning nozzle configured to attach to the handheld device and to deliver laser radiation emitted in the cleaning mode onto the surface to be cleaned.

In accordance with another exemplary embodiment, a cleaning nozzle to be used with a laser processing head configured to deliver laser radiation emitted from a laser source onto a surface to be cleaned is provided. In one example, the cleaning nozzle comprising an opening configured to allow the laser radiation and a gas to be delivered to the surface.

In one example, the cleaning nozzle has a nozzle tip configured with one of: a one-point configuration, a two-point configuration, or a groove. In another example, the nozzle tip is configured to be coupled onto a tubular body portion of the cleaning nozzle. In another example, the tubular body portion is configured to be coupled to the laser processing head. In another example, the tubular body portion is coupled to the laser processing head with an attachment mechanism. In one example, the laser radiation that is delivered to the surface forms a scan line. In one example, the laser processing head is configured to wobble a laser beam of the laser radiation that is delivered to the surface, the opening configured to accommodate a wobble amplitude of the laser beam.

In accordance with another exemplary embodiment, a system for passivating a surface using laser radiation is provided. In one example, the system includes a laser source configured to generate laser radiation, the laser source configured to emit laser radiation in a modulated continuous wave (CW) mode having a duty cycle less than 100%, a pulse-repetition frequency in a range of 30-55 kilohertz (kHz) inclusive, and a FWHM pulse duration of nanosecond order or longer, a housing configured as a handheld apparatus that directs the laser radiation to the surface, and an optical fiber coupling the handheld apparatus to the laser source.

In one example, the modulated CW mode has a maximum power of 1500 watts (W) inclusive.

In one example, the duty cycle is in a range of 10-95% inclusive.

In one example, the FWHM pulse duration is up to millisecond order inclusive.

In one example, the system further includes at least one movable mirror positioned within the housing, the at least one movable mirror configured to wobble a laser beam of the laser radiation such that the laser beam has a wobble amplitude greater than 5 mm.

In one example, the system further includes a cleaning nozzle configured to attach to the housing and to deliver laser radiation emitted in the passivation mode onto a surface to be passivated.

In one example, the cleaning nozzle is configured with an opening that permits the passage of the laser radiation and delivers gas to the surface.

In one example, the laser radiation forms a scan line on the surface.

In one example, the opening is further configured such that a laser beam of the laser radiation has a wobble amplitude of 15 mm.

In accordance with another embodiment, there is provided a method for passivating a surface with a laser. In one example, the method includes providing a laser source, the laser source configured to emit laser radiation in a modulated continuous wave (CW) mode having a duty cycle less than 100%, a pulse-repetition frequency in a range of 30-55 kilohertz (kHz) inclusive, and a FWHM pulse duration of nanosecond order or longer, generating laser radiation from the laser source in the modulated CW mode, and directing the laser radiation emitted from the laser source onto a surface to be passivated.

In one example, the modulated CW mode has a maximum power of 1500 watts (W) inclusive.

In one example, the duty cycle is in a range of 10-95% inclusive.

In one example, the FWHM pulse duration is up to millisecond order inclusive.

In one example, the method further includes wobbling a laser beam of the emitted laser radiation such that the laser beam has a wobble length greater than 5 mm.

In one example, the method further includes providing a handheld device that emits the laser radiation. In a further example, the method further includes providing a cleaning nozzle configured to attach to the handheld device and to deliver laser radiation emitted in the modulated CW mode onto the surface to be passivated.

In one example, the surface comprises a weld seam, and the laser radiation is directed to the weld seam.

In one example, the surface is a metal material comprising one of: nickel, nickel alloys, Inconel, titanium, titanium alloys, and stainless steel.

In accordance with another exemplary embodiment there is provided a system for passivating a surface using laser radiation. In one example, the system includes a laser source configured to generate laser radiation, the laser source configured to emit laser radiation in a continuous wave (CW) mode having a maximum power of 1500 watts (W) inclusive, a housing configured as a handheld apparatus that directs the laser radiation to the surface, and an optical fiber coupling the handheld apparatus to the laser source.

In one example, the system further includes at least one movable mirror positioned within the housing, the at least one movable mirror configured to wobble a laser beam of the laser radiation such that the laser beam has a wobble amplitude greater than 5 mm. In one example, the system further includes a cleaning nozzle configured to attach to the housing and to deliver laser radiation emitted in the CW mode onto a surface to be passivated. In another example, the cleaning nozzle is configured with an opening that permits the passage of the laser radiation and to deliver gas to the surface. In one example, the laser radiation forms a scan line on the surface. In one example, the opening is further configured such that a laser beam of the laser radiation has a wobble amplitude of 15 mm.

In accordance with another exemplary embodiment, a method for passivating a surface with a laser is provided. In one example, the method includes providing a laser source, the laser source configured to emit laser radiation in a continuous wave (CW) mode having a maximum power of 1500 watts (W) inclusive, generating laser radiation from the laser source in the CW mode, and directing the laser radiation emitted from the laser source onto a surface to be passivated.

In one example, the method further includes wobbling a laser beam of the emitted laser radiation such that the laser beam has a wobble length greater than 5 mm.

In one example, the method further includes providing a handheld device that emits the laser radiation.

In one example, the method further includes providing a cleaning nozzle configured to attach to the handheld device and to deliver laser radiation emitted in the CW mode onto the surface to be passivated.

In one example, the surface comprises a weld seam, and the laser radiation is directed to the weld seam.

In one example, the surface is a metal material comprising one of: nickel, nickel alloys, Inconel, titanium, titanium alloys, and stainless steel.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic representation of one example of a handheld laser system according to aspects of the present disclosure;

FIG. 2A is a photograph of one non-limiting example of a cleaning nozzle attached to a handheld laser in accordance with aspects of the disclosure;

FIG. 2B is a perspective view of an example of a cleaning nozzle attached to a handheld laser in accordance with aspects of the disclosure;

FIG. 3 is a perspective view of one non-limiting example of a two-point cleaning nozzle in accordance with aspects of the present disclosure;

FIG. 3A is a photograph of one non-limiting example of a two-point cleaning nozzle attached to a handheld laser in accordance with aspects of the disclosure;

FIGS. 3B and 3C are photographs showing front and perspective views, respectively, of a cleaning nozzle emitting laser radiation in a cleaning procedure in accordance with aspects of the disclosure;

FIG. 4 is a perspective view of one non-limiting example of a cleaning nozzle configured with a grooved tip in accordance with aspects of the present disclosure;

FIG. 5 is a perspective view of one non-limiting example of a one-point cleaning nozzle configured with a ball end tip in accordance with aspects of the present disclosure; and

FIG. 6 is a schematic representation of cleaning nozzles attached to a laser head in accordance with aspects of the invention.

### DETAILED DESCRIPTION

Reference is made herein to PCT International Application No. PCT/US2021/047498, hereafter referred to as “the base handheld laser application,” which is owned by Applicant and incorporated herein by reference in its entirety. The base handheld laser application describes a handheld laser system that includes an air-cooled laser source that is coupled to a handheld component via an optical fiber. The handheld laser system has power capabilities that are on the order of at least 1 kW and is configured with beam wobbling capability.

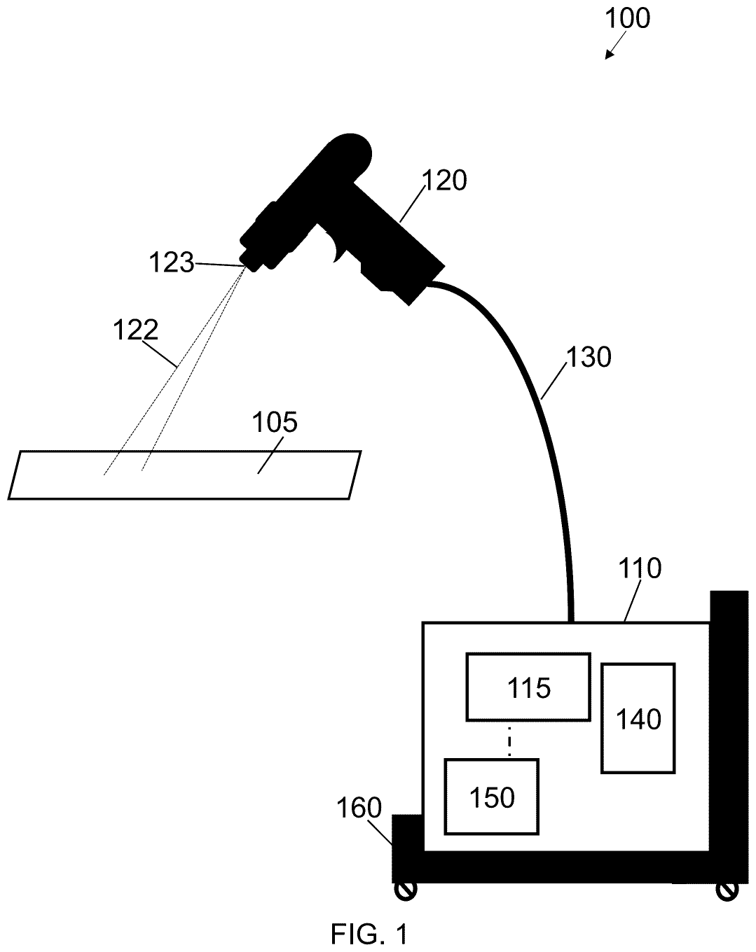

FIG. 1 illustrates a schematic of one example of a handheld laser system 100 that has similarities to the handheld laser system disclosed in the base handheld laser application. These similarities include a laser source 115, a controller or control system 150, a housing that is configured as a handheld apparatus 120 (also referred to herein as a handheld device), an optical fiber 130 that couples the laser source 115 to the handheld apparatus 120, a laser module 110 that houses the laser source 115, the controller 150, and an air-cooling system 140 that cools the laser source 115. The laser module 110 can be mounted to a movable cart 160. The laser source 115 emits laser light at a wavelength (e.g., Yb 1030-1090 nm) for performing a material processing operation on the workpiece 105 with a laser beam 122 of the emitted laser light. The handheld apparatus 120 is also configured with beam wobbling capability.

The housing configured as a handheld apparatus 120 has an outlet 123 or exit for the laser beam 122. Throughout the present description, the term “handheld” is understood to refer to a laser device that is both small and light enough to be readily held in and operated by one or both hands of a user. Furthermore, the handheld laser device should be portable, so that it may be easily moved around by the user during laser processing. However, while embodiments of the present invention are referred to as “handheld” and may be used as standalone portable devices, the handheld laser device may, in some embodiments, be connected to and used in combination with stationary equipment.

### Cleaning Mode

Certain embodiments described herein include some additional functionalities that were developed for the handheld laser system associated with the base handheld laser application. Specifically, one additional functionality has to do with a cleaning mode of operation.

In accordance with at least one embodiment, the cleaning mode can be characterized as a modulated continuous wave (CW) mode having a duty cycle of less than 100%, a pulse-repetition frequency of at least 10 kilohertz (kHz), and a FWHM pulse duration in a range of 1 microsecond (μs) to 10 milliseconds (ms) inclusive. The cleaning mode of operation is implemented through the controller 150 that controls the laser source 115.

In some embodiments, the cleaning mode operates with a laser pulse frequency in a range of 10-60 kHz inclusive, and in further embodiments the pulse frequency is in a range of about 10-55 kHz inclusive. The modulated CW mode configuration provides a sufficiently high repetition rate (e.g., 10 s of kHz) so as to appear CW to the cleaning surface.

The cleaning mode may also be characterized by having a maximum power of 1500 watts (W) inclusive. In some embodiments, the cleaning mode has a power of at least 1 kilowatt (kW). In some embodiments, the cleaning mode has a power of about 1500 W. Cleaning at over 1 kW offers a higher quality and faster cleaning process than cleaning at lower laser powers, which is the power offered by many conventional laser cleaning techniques. Furthermore, the inventors found that higher laser powers, including pulsed laser radiation with high peak powers, did not add any additional cleaning benefit. For instance, cleaning with a kHz level frequency and a peak power of 2500 W did not clean significantly better than the same level frequency and a maximum power of 1500 W.

The cleaning mode also operates with a duty cycle of up to 100%. In some embodiments, the duty cycle is in a range of 10-99% inclusive, and in other embodiments the duty cycle is in a range of 10-95% inclusive. Lower duty cycles may be used in cleaning applications that need only light cleaning, such as light surface contamination with oil, whereas higher duty cycles may be used in certain applications where speed is important and/or where a heavier cleaning is necessary, such as in instances where a film of unwanted material (e.g., paint, rust) exists on the surface to be cleaned.

The cleaning mode of operation using modulated CW is distinguishable from other cleaning modes, such as CW or pulsed modes of cleaning. For one thing, the modulated CW output allows for enhanced flexibility in the cleaning process. Some cleaning applications benefit from using a lower duty cycle, which also means a lower cleaning speed, while other applications benefit from a higher cleaning speed offered by the higher duty cycle. For instance, a cleaning operation performed with a duty cycle of 100% will be 10 times faster than one performed with a duty cycle of 10%. In addition, a “pure” pulsed mode of cleaning is much slower than the modulated CW cleaning mode described herein.

The handheld system 100 is also configured with wobbling capability. At least one movable mirror may be positioned within the housing 120 that is configured to wobble the laser beam 122. The movable mirror reflects and moves the laser beam, i.e., wobbles, the laser beam in one axis. The cleaning mode is also configured to implement beam wobbling, but it is distinguishable from other modes of operation that use wobble. For example, in operating modes other than cleaning mode, the wobble motion oscillates the laser beam 122 back and forth and has a maximum wobble length (also referred to as wobble amplitude) of 5 mm. For the cleaning mode, the wobble amplitude has the ability to be greater than 5 mm. This allows the laser radiation to treat a greater surface area on the workpiece. In one embodiment, the wobble amplitude may be greater than 5 mm and up to 15 mm inclusive. In accordance with at least one embodiment, the wobble amplitude is greater than 5 mm and is up to 23 mm inclusive. According to other embodiments, the wobble amplitude is greater than 5 mm and is up to 25 mm inclusive.

Although the cleaning mode described herein refers to cleaning the workpiece surface, in some instances the cleaning process can include polishing the surface. This may depend on the type of surface as well as the operating parameters for the cleaning mode. In some instances, a target metric for Rms surface roughness and/or water contact angle can be used as a target value in controlling the cleaning mode of operation. This can be either implemented with a feedback mechanism or a predetermined set of operating parameters that achieve the desired target value.

### Cleaning Nozzle Examples

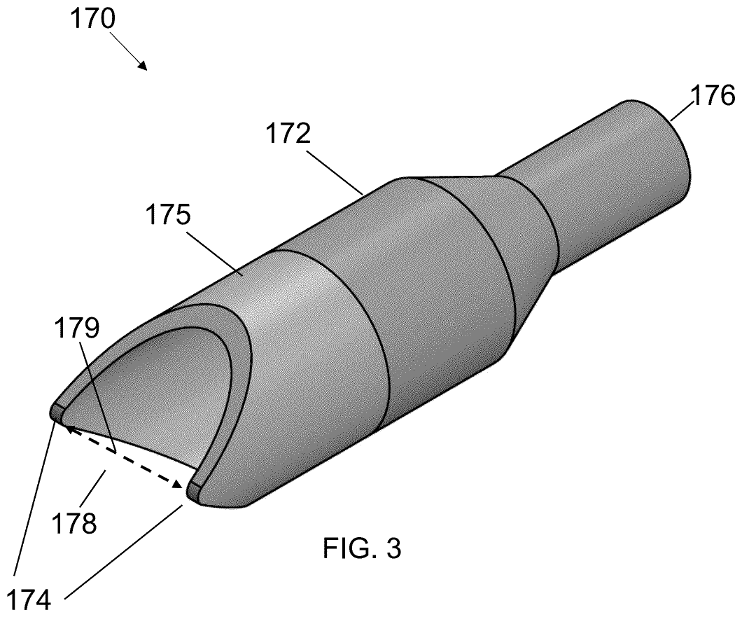

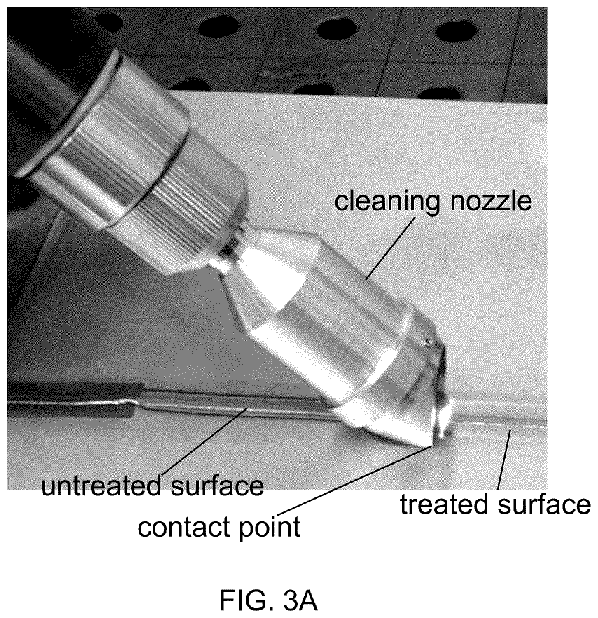

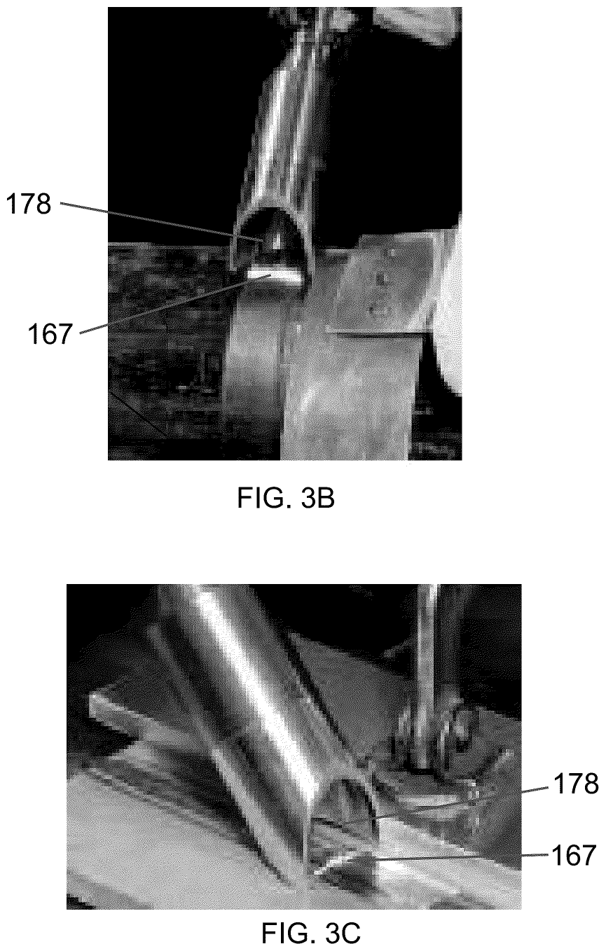

In accordance with at least one embodiment, a cleaning nozzle can be included with the handheld laser for performing cleaning operations. FIGS. 3, 4, and 5 are perspective views of three non-limiting examples of cleaning nozzles 170, 180, and 190 that can be included or otherwise paired with the handheld laser for performing cleaning operations.

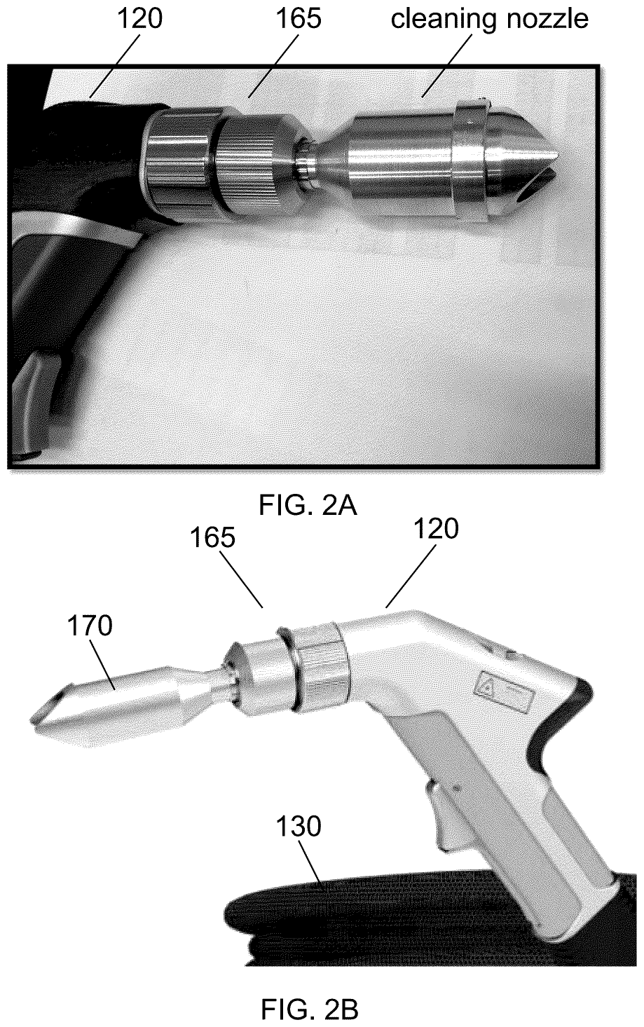

The cleaning nozzles 170, 180, 190 are each configured to attach to the housing 120 of the handheld laser and to deliver laser radiation emitted by the laser source onto a surface to be cleaned. The cleaning nozzles 170, 180, 190 attach to the housing 120 of the handheld laser with an attachment mechanism 165 (e.g., see FIGS. 2A and 2B) as described in co-pending U.S. Provisional Patent Application No. 63/212,290, which is owned by Applicant and incorporated by reference in its entirety.

Each of the cleaning nozzles 170, 180, and 190 comprises a tubular body portion 172 (also referred to as a main body portion). One end of the tubular body portion 172 attaches to the housing 120 (e.g., see FIGS. 2A and 2B) and is configured with an inlet port 176 where laser radiation and gas enter the nozzle. The other end of the tubular body portion 172 is configured with a nozzle tip (also referred to as a contact tip), with three different examples of nozzle tips 175, 185, and 195 being shown in FIGS. 3, 4, and 5, respectively. The nozzle tips 175, 185, 195 can couple or otherwise attach to the tubular body portion 172 any one of a number of different ways, including a press fit attachment. Other attachment mechanisms are also within the scope of this disclosure, including a threaded or mechanical attachment. In some embodiments, nozzle tips 175, 185, and 195 are interchangeable with the tubular body portion 172, making it easy for a user to exchange nozzle tips when performing different cleaning configurations. The tubular body portion 172 and the nozzle tips 175, 185, 195 can be constructed from any one of a number of different materials, including metal and metal alloys. In some embodiments, the nozzle is made from aluminum, aluminum alloys, or steel. The cleaning nozzles can be constructed from any material that does not detrimentally interfere with the cleaning process, and may be application specific.

A first example of a nozzle tip 175 is shown in FIG. 3. Nozzle tip 175 is configured with a two-point (also referred to as two-prong) configuration. Each contact point 174 has a rounded shape so as to prevent damage (e.g., scratching or marring) to the surface of the workpiece being cleaned or otherwise treated. In addition, according to some embodiments, the contact point 174 may be manufactured from a material that is softer than the workpiece material to prevent damage to the workpiece. According to one embodiment, nozzle tip 175 is constructed from aluminum alloy.

Nozzle tip 175 includes an outlet port 178 (also referred to simply as an outlet or opening) configured to allow laser radiation and gas to be delivered to the surface being treated. According to at least one embodiment, the gas can be air, and in other instances an inert or semi-inert gas (e.g., a shielding gas) may be used. Nozzle tip 175 may be used for pre-weld and/or post-weld cleaning. An example of a cleaning nozzle similar to nozzle 170 that is being used in a cleaning operation is shown in FIG. 3A. The contact points rest on the surface to be cleaned, and laser radiation is emitted through the outlet port between the two contact tips. The contact tips make it easier for the user to guide the handheld laser along the surface as it is being processed.

In some embodiments, the laser radiation forms a scan line 167 on the surface. For instance, the laser radiation forms a scan line between the two contact points, as shown in FIGS. 3B and 3C. In certain embodiments the outlet port 178 is configured such that the laser radiation that is delivered to the surface forms a scan line. For instance, the distance 179 between the contact points 174 can be dimensioned to allow for the scan line. The laser processing head, e.g., the handheld laser device, can be configured to oscillate or wobble a laser beam of the laser radiation that is delivered to the surface, and the distance 179 between contact points 174 of the outlet port 178 are configured to accommodate a wobble amplitude of the laser beam. For example, the laser radiation delivered during a cleaning mode described above can be implemented with a wobble amplitude greater than 5 mm. The outlet dimension 179 is configured to accommodate this amplitude. According to some embodiments, the distance or dimension 179 between the contact points 174 is configured to accommodate a 15 mm wobble amplitude. In other embodiments, the distance 179 is configured to accommodate a 25 mm wobble amplitude.

In accordance with at least one embodiment, cleaning nozzle 170 (and cleaning nozzles 180 and 190 described below) is also compatible or otherwise enables the functionality of at least one safety interlock, e.g., a safety conductive interlock (SCI). For example, a laser interlock system that comprises one or more sensors, the controller 150, the laser source, the processing head (e.g., handheld device 120), and the nozzle 170 can be used to ensure that laser radiation is not emitted from the laser source unless the nozzle 170 is touching the work surface. During use, the controller will only activate power to the laser source if the safety interlock is engaged, e.g., the nozzle is touching the surface. As will be appreciated, this implies that (in most instances) the contacting feature on the nozzle 170 is conductive.

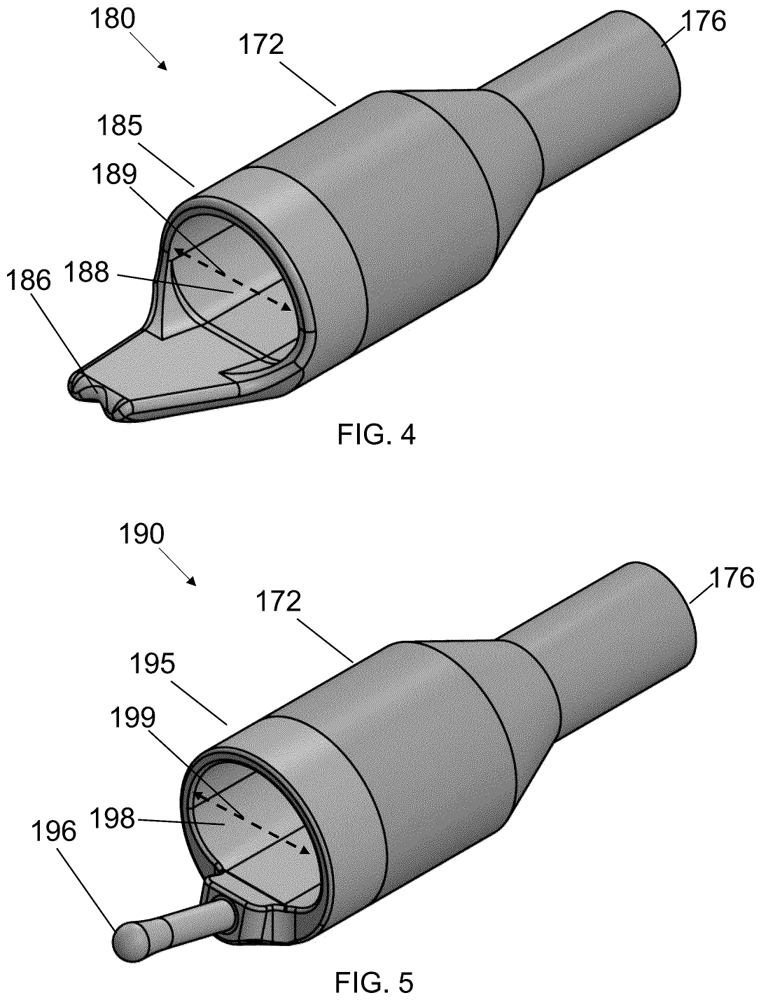

Turning now to FIG. 4, a perspective view is shown of cleaning nozzle 180 having a nozzle tip 185 configured with a groove 186 and can be used with the handheld laser for performing cleaning operations. The grooved configuration can be used in outer corner surface geometries. For instance, the grooved configuration of nozzle tip 185 can be used to position nozzle 180 on an outside corner of the workpiece to clean with the emitted laser energy coming through nozzle outlet port 188 (also referred to herein as simply an outlet or opening). As with outlet port 178 of FIG. 3, outlet port 188 is also configured to emit gas. According to some embodiments, outlet port 188 is also configured to accommodate a wobbling amplitude of the laser beam (e.g., 15 mm) and in some embodiments is configured such that the laser radiation that is delivered to the surface forms a scan line. For example, the diameter 189 of the outlet port 188 may be configured to accommodate a wobble amplitude of the laser beam.

FIG. 5 is a perspective view of a nozzle 190 with a nozzle tip 195 having a one-point (also referred to as one-prong) configuration. In some embodiments, the tip has a ball or rounded end configuration 196, as shown in FIG. 5. In certain embodiments, the rounded end 196 can be used to position the cleaning nozzle on the inside corner of a workpiece surface. In some embodiments, the tip of the one-point configuration has a tip configured to break and/or scratch through (or otherwise remove) a layer of material such as a coating (e.g., a powder coating), paint, rust, etc. that is at least partially covering the workpiece surface. This one-point configuration may be used to break through these coating materials to make contact with the workpiece surface so that the emitted laser radiation coming through nozzle 185 can clean this surface. In some instances the nozzle tip 195 may be constructed from a material that is harder than the material being removed, such as paint or an oxide layer. As with cleaning nozzles 170 and 180, cleaning nozzle 190 is configured to attach to the housing 120 of the handheld laser and is configured to deliver laser radiation and gas onto a surface through outlet port 198 (also referred to as simply an outlet or opening). In addition, in some embodiments, the outlet port 198 is also configured to accommodate a wobbling amplitude of the laser beam, e.g., a wobble amplitude of 15 mm, and is configured such that the laser radiation that is delivered to the surface forms a scan line. For example, the diameter 199 of the outlet port 198 may be configured to accommodate a wobble amplitude of the laser beam.

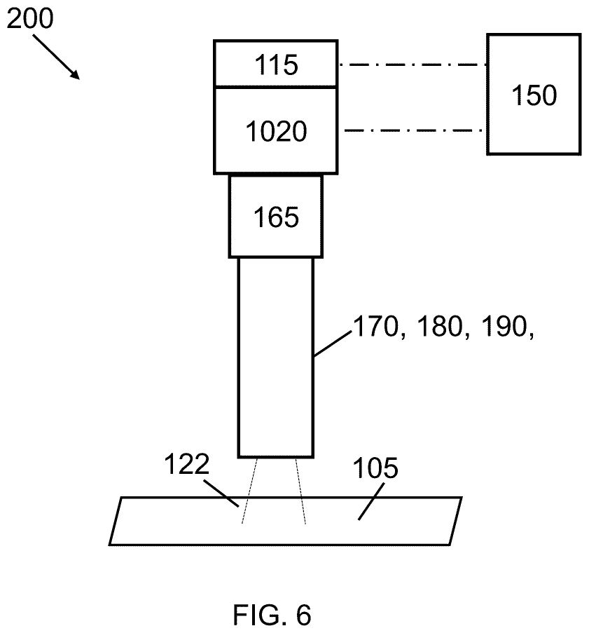

Although the examples described herein refer to a cleaning nozzle used in combination with a handheld laser device, it is to be appreciated that the cleaning nozzle can be used with any one of a number of different laser processing heads, not just those that are handheld. An example of a laser system 200 with a laser head 1020 is shown in the schematic representation of FIG. 6. The laser processing head 1020 (also referred to simply as a laser head) is configured to deliver laser radiation emitted from the laser source 115 onto a surface 105 to be cleaned. The laser head 1020 directs laser radiation from a laser source out an output end of the laser head. The laser head 1020 may not contain the laser source 115, but does include optics and beam guiding components that are included in a housing so as to direct the laser radiation emitted from the laser source 115. Nozzles 170, 180, and 190 couple to the laser processing head 1020 using the attachment mechanism 165. Gas also exits the output end of the laser head 1020 and is directed to the workpiece, e.g., through the nozzle as described herein. Laser radiation exits the nozzle as laser beam 122. Furthermore, passivation processes (discussed in more detail below) may be performed using the laser processing head 1020 and are therefore also not just limited to a handheld laser device. Controller 150 is also coupled to the laser head 1020 and laser source 115 for purposes of sending control signals, and in some instances receiving feedback and/or input signals.

### Passivation

In accordance with another aspect, the handheld laser may be used to perform passivation on metal surfaces. Passivation can be considered as a form of cleaning. Passivation creates a corrosion-resistant surface that prevents corrosion from both occurring and migrating into the treated area. Using a laser to perform passivation provides several advantages over other passivation processes, such as chemical passivation, which impacts the entire workpiece surface and creates chemical waste. The laser can be used to passivate a targeted area and there is no use of chemicals that have to be disposed of. The effect of the laser energy in a passivation process functions to remove free iron from the workpiece surface so that the iron cannot then react with oxygen in the air and form rust. As with welding, passivation may be performed in the presence of a gas such as argon or nitrogen.

Passivation may be performed on any one of a number of metal surfaces. In some embodiments, the metal material comprises one of nickel, nickel alloys, Inconel, titanium, titanium alloys, and stainless steel. It is to be appreciated that this list is not exhaustive and in fact the metal material may extend to any metal that has iron content or may be contaminated with iron. According to at least one embodiment, laser radiation configured for performing passivation may be applied to a weld seam. For instance, the surface to be treated may comprise a weld seam (e.g., a butt joint of metal material(s)), and the laser radiation is directed to the weld seam to passivate it. In some instances, the laser radiation may be passed over the weld seam more than once, e.g., a forward and reverse pass. In some instances, passivation may be performed immediately or within a short time period after welding so that oxidation does not have a chance to occur. It is to be appreciated that passivation may also be performed on a metal surface (other than a weld seam) to protect it from corrosion.

In accordance with some embodiments, the laser source 115 is controlled by the controller 150 to emit laser radiation in a passivation mode. According to certain embodiments, a cleaning nozzle as described above in reference to cleaning nozzles 170, 180, and/or 190 may be used to perform passivation operations. As such, the cleaning nozzle is configured to attach to a housing of a handheld apparatus or of a laser head to deliver laser radiation emitted in the passivation mode onto a surface to be passivated. The cleaning nozzle is configured with an opening (e.g., opening 178, 188, 198) that permits passage of the laser radiation and gas, as previously described. In addition, the laser radiation may form a scan line on the surface, such as scan line 167 in FIGS. 3B and 3C. As also previously discussed, the opening (e.g., opening 178, 188, 198) is configured to accommodate a wobble amplitude of the laser beam. In some embodiments the wobble amplitude is 15 mm.

The passivation mode can be further sub-categorized into fine passivation and high speed passivation. In a fine passivation mode, the laser source 155 is configured to emit laser radiation in modulated CW mode having a duty cycle less than 100%, a pulse-repetition frequency in a range of 30-55 kHz inclusive, and a FWHM pulse duration of nanosecond order or longer. In some embodiments the duty cycle for the modulated CW mode is in a range of 10-99% inclusive, and in other embodiments, the duty cycle is in a range of 10-95% inclusive. In some embodiments, the pulse-repetition frequency for the modulated CW mode is in a range of 30-50 kHz inclusive. In some embodiments, the pulse duration is of microsecond (μs) order or longer. In some embodiments the FWHM pulse duration is of microsecond order up to millisecond (ms) order inclusive. In one embodiment, the FWHM pulse duration is in a range of 0.5-10 ms inclusive, and in other embodiments, the FWHM pulse duration is in a range of 0.5-5 ms inclusive. An experiment performed with fine passivation on different metal surface is described below. In a high speed passivation mode, the laser source 115 is configured to emit laser radiation in a continuous (CW) mode having a maximum power of 1500 W inclusive.

### Experiment With Fine Passivation Mode

A series of butt-joint welds performed on different materials were exposed to laser radiation configured in a fine passivation mode and the results were compared in salt fog testing conditions against controls (i.e., no passivation was applied post-weld). The laser power for the fine passivation mode was implemented in 2 settings: the first at 650 W with a pulse-repetition frequency of 55 kHz (1.2 ms pulse duration), and the second at 800 W with a pulse-repetition frequency of 60 kHz (1.1 ms pulse duration). In both instances, the duty cycle was 65%, the wobble amplitude was 8 mm, and two passes were made over each weld seam. The salt fog tests (i.e., in accordance with ASTM B117-19) were performed at 95° F. at a 30 degree angle for 2 hours.

Table 1 below lists the materials and their thicknesses that were treated and indicated enhanced protection (i.e., little or no oxidation formation) from the passivation treatment (at both settings) as compared to their respective control.

TABLE 1
fine passivation mode materials and thicknesses

| Material | Thickness (inches) |
|---|---|
| High Strength 625 Nickel | 0.02 |
| Ultra Strength 718 Nickel | 0.02 |
| Ultra Corrosion Resistant Alloy 22 Nickel | 0.025 |
| Ultra High Temperature Alloy Nickel | 0.02 |
| Polished Economical 430 Stainless Steel | 0.035 |
| Hardened Corrosion Resistant 316 Stainless Steel | 0.031 |
| High Strength 17-4 PH Stainless Steel | 0.04 |
| High Strength Grade 5 Titanium | 0.016 |
| Ultra Corrosion Resistant Grade 2 Titanium | 0.02 |

The present disclosure provides methods and systems for cleaning and/or passivating a surface using laser radiation. For example, a pre-weld cleaning system and method disclosed herein provides the capability to remove oxides, rusts, oils, and greases, and the post-weld cleaning system and method provide the capability to polish the weld or remove any soot or debris. Both cleaning applications eliminate the need for harmful chemicals or abrasives and require minimal material preparation or post-finishing.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls. Moreover, titles or subtitles may be used in the specification for the convenience of a reader, which shall have no influence on the scope of the present invention.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system for passivating a surface using laser radiation, the system comprising:
a laser source configured to generate laser radiation, the laser source configured to emit laser radiation in a modulated continuous wave (CW) mode having a duty cycle less than 100%, a pulse-repetition frequency in a range of 30-55 kilohertz (kHz) inclusive, and a FWHM pulse duration of nanosecond order or longer;
a housing configured as a handheld apparatus that directs the laser radiation to the surface; and
an optical fiber coupling the handheld apparatus to the laser source.

2. The system of claim 1, wherein the modulated CW mode has a maximum power of 1500 watts (W) inclusive.

3. The system of claim 1, wherein the duty cycle is in a range of 10-95% inclusive.

4. The system of claim 1, wherein the FWHM pulse duration is up to millisecond order inclusive.

5. The system of claim 1, further comprising at least one movable mirror positioned within the housing, the at least one movable mirror configured to wobble a laser beam of the laser radiation such that the laser beam has a wobble amplitude greater than 5 mm.

6. The system of claim 1, further comprising a cleaning nozzle configured to attach to the housing and to deliver laser radiation emitted in the passivation mode onto a surface to be passivated.

7. The system of claim 6, wherein the cleaning nozzle is configured with an opening that permits the passage of the laser radiation and delivers gas to the surface.

8. The system of claim 7, wherein the laser radiation forms a scan line on the surface.

9. The system of claim 7, wherein the opening is further configured such that a laser beam of the laser radiation has a wobble amplitude of 15 mm.

10. A system for passivating a surface using laser radiation, the system comprising:
a laser source configured to generate laser radiation, the laser source configured to emit laser radiation in a continuous wave (CW) mode having a maximum power of 1500 watts (W) inclusive;
a housing configured as a handheld apparatus that directs the laser radiation to the surface; and
an optical fiber coupling the handheld apparatus to the laser source.

11. The system of claim 10, further comprising at least one movable mirror positioned within the housing, the at least one movable mirror configured to wobble a laser beam of the laser radiation such that the laser beam has a wobble amplitude greater than 5 mm.

12. The system of claim 10, further comprising a cleaning nozzle configured to attach to the housing and to deliver laser radiation emitted in the CW mode onto a surface to be passivated.

13. The system of claim 12, wherein the cleaning nozzle is configured with an opening that permits the passage of the laser radiation and to deliver gas to the surface.

14. The system of claim 13, wherein the laser radiation forms a scan line on the surface.

15. The system of claim 13, wherein the opening is further configured such that a laser beam of the laser radiation has a wobble amplitude of 15 mm.
